(19) United States
(12) Patent Application Publication
(10) Pub. No.: US 2016/0162936 A1
(43) Pub. Date: Jun. 9, 2016

(54) NOTIFICATION OF POSSIBLE CUSTOMERS

(71) Applicant: EBAY INC., San Jose, CA (US)

(72) Inventor: Syed Muasir Khalil, Austin, TX (US)

(21) Appl. No.: 14/565,292

(22) Filed: Dec. 9, 2014

(51) Int. Cl. G06Q 30/02

(52) U.S. Cl. CPC G06Q 30/0254; G06Q 30/0261; G06Q 30/0269

(57) ABSTRACT

Methods and systems for enhancing a customer experience are described. Merchants are notified of potential customers and their estimated times of arrival. In some cases, potential customers are identified by analysis of their current actions, such as browsing a website of a merchant or looking up directions to a merchant. Merchants can prepare themselves and their employees based on the number and/or type of expected customers and forecasted demand for goods and/or services. Merchants can also send incentives to identified potential customers to bring the customers into their store.

### BACKGROUND

1. Field of the Invention

The present invention generally relates to enhancing customer service based on estimated time of arrival of potential customers.

2. Related Art

An on-going issue for many small and large businesses alike is how to accurately predict the flow of customer traffic to more efficiently and effectively staff the businesses and to ensure sufficient inventory is on hand to meet fluctuating customer demand. A business owner can estimate customer flow based on historical data, but this data is often insufficient and/or inaccurate. Thus, there exists a need to improve the process of informing a business of the arrival of potential customers.

### BRIEF DESCRIPTION OF THE FIGURES

FIG. 1 is a block diagram illustrating a system for enhancing customer service according to an embodiment of the present disclosure;

FIG. 2 is a block diagram illustrating a service provider server according to an embodiment of the present disclosure.

FIG. 3 is a flowchart showing a method for enhancing customer service according to an embodiment of the present disclosure; and

FIG. 4 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes systems and methods for providing an enhanced in-store retail experience to a consumer. A service provider determines that a user/consumer intends to visit a merchant by, for example, learning of the user's plans from a calendar application. The service provider tracks the location of the user and provides an estimated time of arrival at a merchant location to the merchant. The merchant, upon notification by the service provider of a particular user and arrival time, can prepare for that particular user. For example, the merchant can ensure that items or services typically purchased by the particular user are available and that a particular employee is available to tend to the particular user.

In various embodiments, the service provider provides user profile information to the merchant. The user profile includes any information the service provider has received or collected about the user, such as where the user has shopped in the past (including competing stores), what the user has bought in the past, what the user has searched for in the past, how much the user has spent in the past, and/or how much time the user generally spends shopping or shopping at a certain store or type of store. In certain embodiments, the merchant is also given information regarding the user's schedule, e.g., how long the user has to shop at the merchant. Schedule information can be obtained from a calendar application and/or routine or past activity of the user. The merchant can then provide or transmit incentives to the user based on any or all of this information. The incentives, in some embodiments, are based on the user profile, estimated time of arrival, and/or schedule.

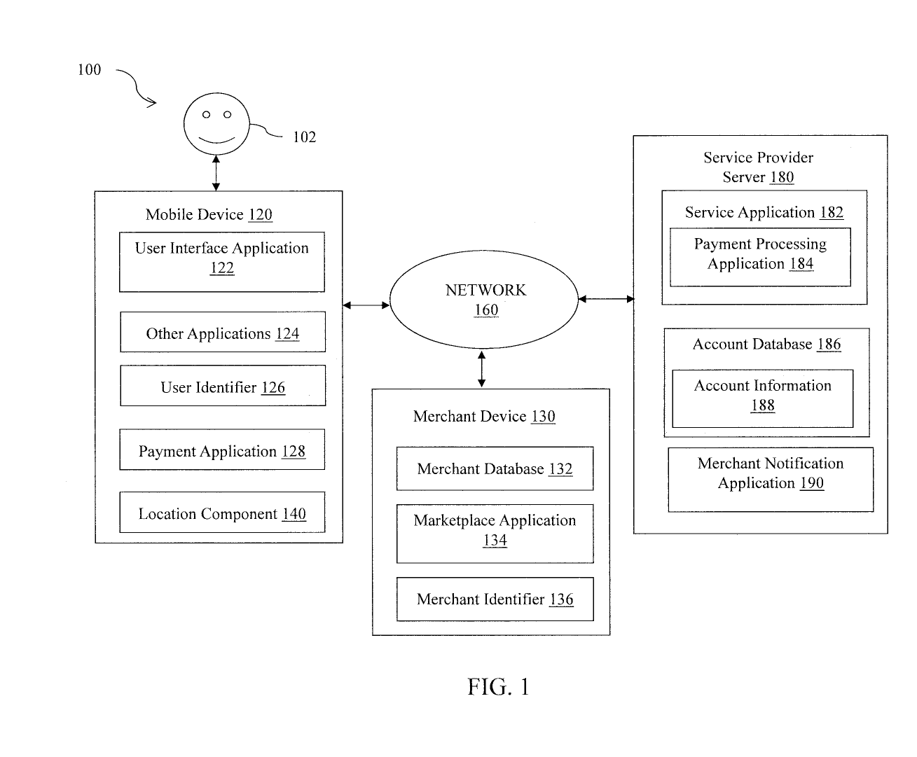

FIG. 1 shows one embodiment of a block diagram of a network-based system 100 adapted to enhance customer service. As shown, system 100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

As shown in FIG. 1, the system 100 includes a mobile device 120 (e.g., a smartphone), one or more merchant servers or devices 130 (e.g., network server devices), and at least one service provider server or device 180 (e.g., network server device) in communication over the network 160. In other embodiments, a third-party system (not shown) may be connected to the other systems over the network 160 in the same way as described herein with respect to the other systems. The third-party system, in some embodiments may be used to receive and transmit user location data. The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet.

The mobile device 120, in one embodiment, may be utilized by the user 102 to interact with the merchant device 130 and/or the service provider server 180 over the network 160. For example, the user 102 may conduct financial transactions (e.g., account transfers) with the service provider server 180 via the mobile device 120. The mobile device 120, in various embodiments, may be implemented using any appropriate combination of hardware and/or software configured for wired and/or wireless communication over the network 160. In various implementations, the mobile device 120 includes a wireless telephone (e.g., cellular or mobile phone), a tablet, a notebook computer, a wearable computing device, and/or various other generally known types of wired and/or wireless computing devices.

The mobile device 120, in one embodiment, includes a user interface application 122, which may be utilized by the user 102 to conduct transactions (e.g., shopping, purchasing, bidding, etc.) with the merchant device 130 and/or service provider server 180 over the network 160. In one aspect, purchase expenses may be directly and/or automatically debited from an account related to the user 102 via the user interface application 122.

In one implementation, the user interface application 122 comprises a software program, such as a graphical user interface (GUI), executable by a processor that is configured to interface and communicate with the service provider server 180 via the network 160. In another implementation, the user interface application 122 comprises a browser module that provides a network interface to browse information available over the network 160. For example, the user interface application 122 may be implemented, in part, as a web browser to view information available over the network 160.

In an example, the user 102 is able to access merchant websites via the one or more merchant servers 130 to view and select items for purchase, and the user 102 is able to purchase items from the one or more merchant servers 130 via the service provider server 180. Accordingly, in one or more embodiments, the user 102 may conduct transactions (e.g., purchase and provide payment for one or more items) from the one or more merchant servers 130 via the service provider server 180.

The mobile device 120, in various embodiments, may include other applications 124 as may be desired in one or more embodiments of the present disclosure to provide additional features available to user 102. In one example, such other applications 124 may include security applications for implementing client-side security features, programmatic client applications for interfacing with appropriate application programming interfaces (APIs) over the network 160, and/or various other types of generally known programs and/or software applications. In still other examples, the other applications 124 may interface with the user interface application 122 for improved efficiency and convenience.

In various implementations, a user profile may be created using data and information obtained from cell phone activity over the network 160. Cell phone activity transactions may be used by the service provider server 180 to create at least one user profile for the user 102 based on activity from the mobile device 120 (e.g., cell phone). The user profile may be updated with each financial and/or information transaction (e.g., payment transaction, purchase transaction, etc.) achieved through use of the mobile device 120. In various aspects, this may include the type of transaction and/or the location information from the mobile device 120. As such, the profile may be used for recognizing patterns of potential fraud, setting transaction limits on the user, etc.

The mobile device 120, in one embodiment, may include at least one user identifier 126, which may be implemented, for example, as operating system registry entries, cookies associated with the user interface application 122, identifiers associated with hardware of the mobile device 120, or various other appropriate identifiers. The user identifier 126 may include one or more attributes related to the user 102, such as personal information related to the user 102 (e.g., one or more user names, passwords, photograph images, biometric IDs, addresses, phone numbers, social security number, etc.) and banking information and/or funding sources (e.g., one or more banking institutions, credit card issuers, user account numbers, security data and information, etc.). In various implementations, the user identifier 126 may be passed with a user login request to the service provider server 180 via the network 160, and the user identifier 126 may be used by the service provider server 180 to associate the user 102 with a particular user account maintained by the service provider server 180.

Mobile device 120, in various embodiments, includes a location component 140 configured to determine, track, monitor, and/or provide an instant geographical location of mobile device 120. In one implementation, the geographical location may include GPS coordinates, zip-code information, area-code information, street address information, and/or various other generally known types of location information. In one example, the location information may be directly entered into mobile device 120 by user 102 via a user input component, such as a keyboard, touch display, and/or voice recognition microphone. In another example, the location information may be automatically obtained and/or provided by the mobile device 120 via an internal or external monitoring component that utilizes a global positioning system (GPS), which uses satellite-based positioning, and/or assisted GPS (A-GPS), which uses cell tower information to improve reliability and accuracy of GPS-based positioning. In other embodiments, the location information may be automatically obtained without the use of GPS. In some instances, cell signals or wireless signals are used. For example, location information may be obtained by checking in using mobile device 120 via a check-in device at a location, such as a beacon. This helps to save battery life and to allow for better indoor location where GPS typically does not work.

In some embodiments, mobile device 120 supports short-range wireless technologies such as WiFi, Bluetooth™, or Zigbee®. Mobile device 120 can also incorporate a passive or active radio frequency identification (RFID) transmitter and receiver for communicating with RFID-capable devices such as RFID readers.

In certain embodiments, mobile device 120 includes a payment application 128. In one embodiment, a service provider distributes the payment application 128 to mobile device 120 over the network 160. In some embodiments, the payment application 128 receives user information and creates a user profile containing the user information. The payment application 128, in various embodiments, collects information regarding the purchase history of user 102, including items or services purchased, cost of items or services purchased, merchants visited, time spent shopping at various merchants, and times and days that various merchants were visited.

The one or more merchant servers 130, in various embodiments, may be maintained by one or more business entities (or in some cases, by a partner of a business entity that processes transactions on behalf of business entities). Examples of businesses entities include merchants, resource information companies, utility companies, real estate management companies, social networking companies, etc., which offer various items and/or services for purchase and payment. In some embodiments, business entities may need registration of the user identity information as part of offering items to the user 102 over the network 160. As such, each of the one or more merchant servers 130 may include a merchant database 132 for identifying available items, which may be made available to the mobile device 120 for viewing and purchase by the user 102. In one or more embodiments, user 102 may complete a transaction such as purchasing the items via service provider server 180.

Each of the merchant servers 130, in one embodiment, may include a marketplace application 134, which may be configured to provide information over the network 160 to the user interface application 122 of the mobile device 120. For example, user 102 may interact with the marketplace application 134 through the user interface application 122 over the network 160 to search and view various items available for purchase in the merchant database 132.

Each of the merchant servers 130, in one embodiment, may include at least one merchant identifier 136, which may be included as part of the one or more items made available for purchase so that, e.g., particular items are associated with particular merchants. In one implementation, the merchant identifier 136 may include one or more attributes and/or parameters related to the merchant, such as business and banking information. The merchant identifier 136 may include attributes related to the merchant server or device 130, such as identification information (e.g., a serial number, a location address, GPS coordinates, a network identification number, etc.). In various embodiments, user 102 may conduct transactions (e.g., searching, selection, monitoring, purchasing, and/or providing payment for items) with each merchant server 130 via the service provider server 180 over the network 160.

A merchant website may also communicate (for example, using merchant server 130) with the service provider through service provider server 180 over network 160. For example, the merchant website may communicate with the service provider in the course of various services offered by the service provider to a merchant website, such as payment intermediary between customers of the merchant website and the merchant website itself. For example, the merchant website may use an application programming interface (API) that allows it to offer sale of goods in which customers are allowed to make payment through the service provider, while user 102 may have an account with the service provider that allows user 102 to use the service provider for making payments to merchants that allow use of authentication, authorization, and payment services of the service provider as a payment intermediary. The merchant website may also have an account with the service provider.

The service provider server 180, in one embodiment, may be maintained by a transaction processing entity or an online service provider, which may provide processing for financial transactions and/or information transactions between the user 102 and one or more of the merchant servers 130. As such, the service provider server 180 includes a service application 182, which may be adapted to interact with the mobile device 120 over the network 160 to facilitate the searching, selection, purchase, and/or payment of items by the user 102 from the one or more merchant servers 130. In one example, the service provider server 180 may be provided by PayPal®, Inc., eBay® of San Jose, Calif., USA, and/or one or more financial institutions or a respective intermediary that may provide multiple point of sale devices at various locations to facilitate transaction routings between merchants and, for example, financial institutions.

The service application 182, in one embodiment, utilizes a payment processing application 184 to process purchases and/or payments for financial transactions between the user 102 and each of the merchant servers 130. In one implementation, the payment processing application 184 assists with resolving financial transactions through validation, delivery, and settlement. As such, the service application 182 in conjunction with the payment processing module 184 settles indebtedness between the user 102 and each of the merchant servers 130, wherein accounts may be directly and/or automatically debited and/or credited of monetary funds in a manner as accepted by the banking industry.

The service provider server 180, in one embodiment, may be configured to maintain one or more user accounts and merchant accounts in an account database 186, each of which may include account information 188 associated with one or more individual users (e.g., user 102) and merchants. For example, account information 188 may include private financial information of user 102 and merchants (e.g., one or more merchants associated with merchant servers 130), such as one or more account numbers, passwords, credit card information, banking information, or other types of financial information, which may be used to facilitate financial transactions between user 102, and one or more merchants associated with the merchant servers 130. In various aspects, the methods and systems described herein may be modified to accommodate users and/or merchants that may or may not be associated with at least one existing user account and/or merchant account, respectively.

In one implementation, the user 102 may have identity attributes stored with the service provider server 180, and user 102 may have credentials to authenticate or verify identity with the service provider server 180. User attributes may include personal information, banking information and/or funding sources. In various aspects, the user attributes may be passed to the service provider server 180 as part of a login, search, selection, purchase, and/or payment request, and the user attributes may be utilized by the service provider server 180 to associate user 102 with one or more particular user accounts maintained by the service provider server 180.

In various embodiments, the service provider server 180 includes a merchant notification application 190. The merchant notification application 190 determines whether a user will visit a particular merchant, determines or receives a location of a user, estimates a time of arrival of a user, and notifies a merchant of potential customers and their time of arrival. In certain embodiments, the service provider server 180 provides the merchant with a user profile of potential customers. The user profile can include information such as a user's purchase history (e.g., items bought in the past, specific merchants visited, duration of their visits, etc.), personal information, and web browsing habits. The merchant can then prepare for the potential customers by ensuring they have enough employees and the right employees and sufficient stock/inventory and the right stock/inventory. The merchant, in some embodiments, can provide incentives to potential customers based on their time of arrival and/or the duration of their visit.

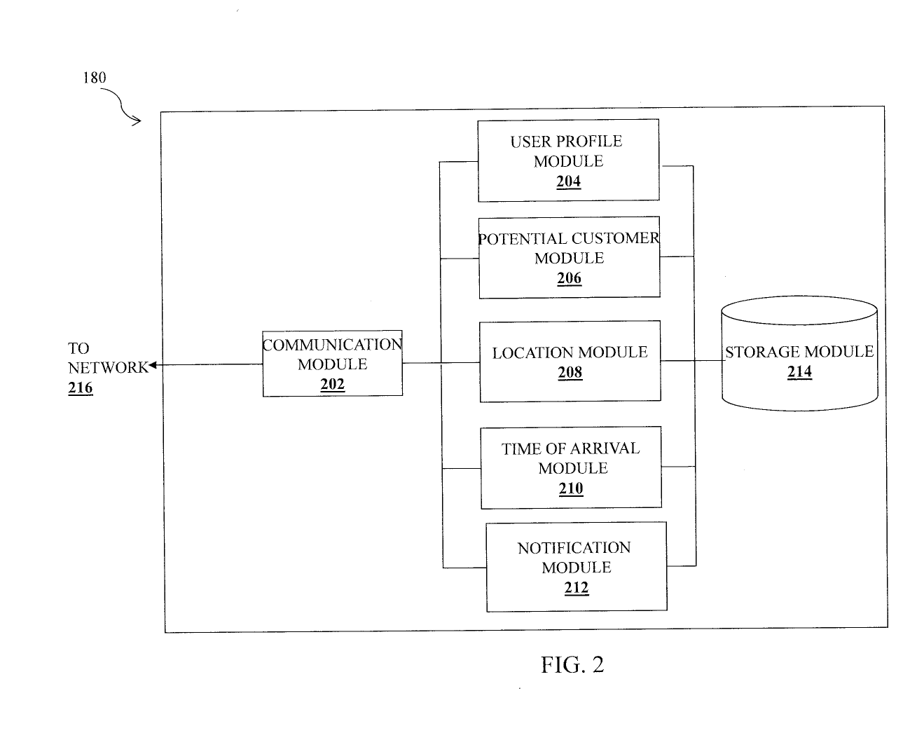

FIG. 2 illustrates an embodiment of the service provider server 180. The server 180 includes several components or modules, such as a communication module 202, user profile module 204, potential customer module 206, location module 208, time of arrival module 210, notification module 212, and storage module 214.

The server 180 includes a communication module 202 that is coupled to the network 216 and to any or all of a user profile module 204, potential customer module 206, location module 208, time of arrival module 210, and notification module 212, any of which may be coupled to a storage module 214. Any or all of the modules 202-212 may be implemented as a subsystem of server 180 including for example, a circuit, a hardware component, a hardware subcomponent, and/or a variety of other subsystems known in the art. Furthermore, any or all of the modules 202-212 may be preconfigured to perform their disclosed functionality, or may be configured by a processing system “on-the-fly” or as needed to perform their disclosed functionality. As such, any or all of the modules 202-212 may include pre-configured and dedicated circuits and/or hardware components of the server 180, or may be circuits and/or hardware components that are configured as needed.

For example, any or all of the modules 202-212 may be provided via one or more circuits that include resistors, inductors, capacitors, voltage sources, current sources, switches, logic gates, registers, and/or a variety of other circuit elements known in the art. One or more of the circuit elements in a circuit may be configured to provide the circuit(s) that cause the modules 202-212 to perform the functions described below. As such, in some embodiments, preconfigured and dedicated circuits may be implemented to perform the functions of the modules 202-212. In other embodiments, a processing system may execute instructions on a non-transitory, computer-readable medium to configure one or more circuits as needed to perform the functions of the modules 202-212.

The communication module 202 may be included as a separate module provided in the server 180, or may be provided using instructions stored on a computer-readable medium that, when executed by a processing system in the server 180, configure the communication module 202 to send and receive information over the network 214, as well as provide any of the other functionality that is discussed herein. The user profile module 204 may be included as a separate module provided in the server 180, or may be provided using instructions stored on a computer-readable medium that, when executed by a processing system in the server 180, configure the user profile module 204 to receive user information to create a user profile and update the user profile, as well as provide any of the other functionality that is discussed herein. User profiles may include personal information such as age, salary/income, address, gender, and occupation and purchase history information such as amounts spent at various merchant locations, items purchased, days and times various merchant locations were visited, and duration of merchant visits. The potential customer module 206 may be included as a separate module provided in the server 180, or may be provided using instructions stored on a computer-readable medium that, when executed by a processing system in the server 180, configure the potential customer module 206 to determine and/or identify possible or potential customers that will visit a merchant location, as well as provide any of the other functionality that is discussed herein. In some embodiments, the potential customer module 206 receives user profile information, schedule or calendar information, and/or other information indicating a user's intention to visit a particular merchant. The location module 208 may be included as a separate module provided in the server 180, or may be provided using instructions stored on a computer-readable medium that, when executed by a processing system in the server 180, configure the location module 208 to determine or receive a location of a user. The time of arrival module 210 may be included as a separate module provided in the server 180, or may be provided using instructions stored on a computer-readable medium that, when executed by a processing system in the server 180, configure the time of arrival module 210 to estimate the time a potential customer will arrive at a merchant location. The notification module 212 may be included as a separate module provided in the server 180, or may be provided using instructions stored on a computer-readable medium that, when executed by a processing system in the server 180, configure the notification module 212 to notify a merchant of potential customers and their estimated time of arrival. Furthermore, other modules discussed above but not illustrated in FIG. 2 may be provided as separate modules on the server 180, or using instructions stored on a computer-readable medium similarly as discussed above. While the storage module 214 has been illustrated as located in the server 180, one of ordinary skill in the art will recognize that it may include multiple storage modules and may be connected to the modules 204-212 through the network 216 without departing from the scope of the present disclosure.

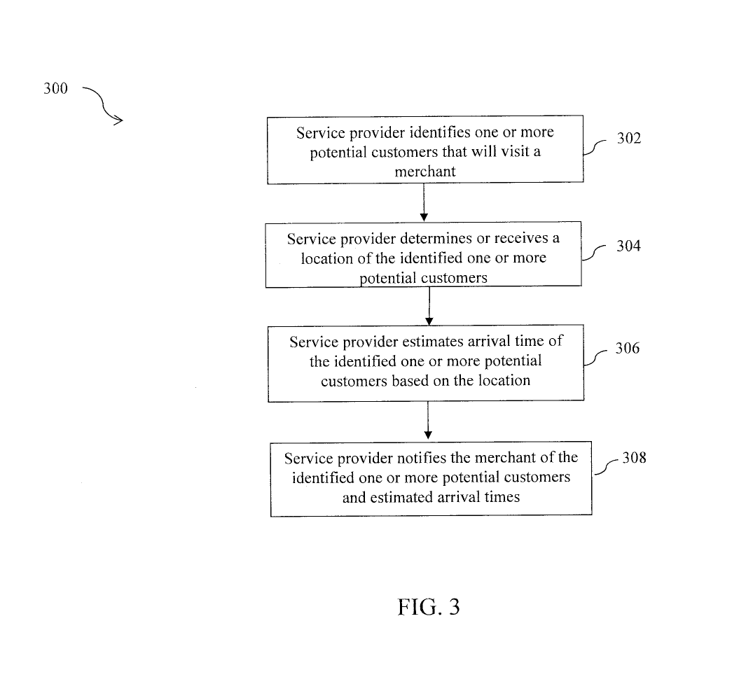

Referring now to FIG. 3, a flowchart 300 of a method for enhancing customer service is illustrated according to an embodiment of the present disclosure. In various embodiments, the user 102 registers with a service provider. Registration may include signing up for the service and agreeing to any terms required by the service provider, such as through mobile device 120. Mobile device 120 may be a mobile computing device, such as a smart phone, a PC, a computing tablet, or a wearable device. In some embodiments, registration may be done completely through the mobile device 120, partially through the mobile device 120, or without using the mobile device 120, such as through a phone call or in-person visit to a representative of the service provider.

User 102 may be requested to provide specific information for registration, such as, but not limited to, a name, address, phone number, email address, picture, biometric data (e.g., fingerprints, retina scan, etc.), available funding sources, a user name for the account, and a password or PIN for the account. The type of information requested may depend on whether the user 102 already has an account with the service provider. Requested information may be entered through the mobile device 120 or other means, including voice or manual key entry. Once all the requested information is received and confirmed, the service provider may create an account for the user.

In some embodiments, the service provider creates a user profile from the user provided information. The user profile may be updated with additional information regarding user 102 and his or her financial transactions. In certain embodiments, the user profile contains information about the user's web browsing habits (e.g., merchant websites frequently visited), demographic information, web journeys at one or more websites (e.g., products searched and bought over the Internet), and the like.

The user profile module 204 can gather data, such as consumer status information associated with the user 102 and store the consumer status information in a user profile. The consumer status information may include at least one of cardmember status, a social media score, a job title, an income level, prior purchasing history, a credit score, and/or available credit. In various embodiments, the consumer status information may be obtained from various third party providers such as, but not limited to, credit card companies, credit rating agencies, and social media websites.

The user profile module 204 may also obtain data about transactions between the user 102 and various merchants (e.g., the merchant associated with merchant server 130) and store the transaction information in a user profile. Transaction data for a transaction may include one or more of the name of a merchant, type of purchased product and/or service, location of purchase, date of purchase, quantity of purchase, amount spent, description of the merchant, mode of payment, transaction card details, and the like. In various embodiments, the user profile module 204 may also obtain transaction data associated with the user 102 from third party service providers such as credit card companies, credit rating agencies, social networks, and the like. Data obtained from third party providers includes, without limitation, consumer spending behavior, credit score, payment history, preferred merchants, frequency of purchases, and the like. The user profile module 204 may store transaction data in the storage module 214.

The user profile module 204 may track information such as a number of customer visits, frequency of customer visits, amount of customer purchases, etc., and store this information in a user profile. In various embodiments, a merchant or user profile module 204 may provide a reward to user 102 in response to the interactions. For example, a reward may include loyalty points, a discount on goods or services, cash, upgrades in service, or any other type of reward. As such, a merchant may be able to promote loyalty among its customers.

At step 302, the potential customer module 206 identifies one or more potential or possible customers that are like to or will visit a merchant location. In one embodiment, the potential customer module 206 accesses third-party applications (e.g., calendar application, map application, web browser application, etc.) available on mobile device 120 to predict the actions of user 102. In several exemplary embodiments, the potential customer module 206 analyzes current and/or past user actions. For example, the potential customer module 206 may determine that user 102 is getting directions to a merchant location (or identify recent searches for locations, attractions, addresses, or the like), that user 102 pre-ordered an item from a merchant and is planning on picking the item up, the user 102 is browsing the website of a merchant, that the user 102 posted on social media that he or she plans to visit a merchant location, that the user 102 scheduled a visit to the merchant location on his or her calendar, etc. In other embodiments, the potential customer module 206 may determine that user 102 has historically visited a merchant location at a specific time of day, day of the week, or date.

In various embodiments, potential customer module 206 analyzes Internet data to identify potential customers of a merchant. Internet data may include any information relating to the searches conducted by the user 102, websites visited by the user 102, or the like that suggests the user 102's present or future travel plans. For instance, in preparing for a vacation user 102 may conduct searches for hotels, restaurants or activities in the area where the user 102 will be staying. Similarly, user 102 may review weather forecasts for locations other than his or her place of residence indicating that he or she may soon be traveling to that location. User 102 may also search for construction or traffic reports indicating future travel along certain roads.

Moreover, changes in search patterns may suggest a user 102's future location. For instance if user 102 usually uses a web browser application just to read online news articles or to check sports scores, but suddenly begins to search for camping gear, hiking manuals and boots it may be indicative that the user 102 is anticipating taking a hiking trip and will be visiting a sports equipment store. It will be understood that such Internet data may relate to searches or websites visited by the user 102 before she began traveling; however, inasmuch as many mobile devices also include mobile Internet connectivity, it will also be understood that such information may be dynamically collected as the user 102 travels.

In one aspect, when interfacing with mobile device 120, user 102 may elect and/or consent to provide personal information, such as user profile information, and access to various applications on mobile device 120, to service provider server 180. User 102 may set or configure the user settings/configuration menu of the mobile device 120. Through the user settings/configuration menu, user 102 may provide consent to share personal information and/or access to applications and specify the extent of the shared personal information and/or access to applications. In some embodiments, user 102 may be prompted for permission to release personal information and/or access to applications. Accordingly, user 102 may have exclusive authority to allow transmission of personal information from and/or access to applications on the mobile device 120 to service provider server 180.

At step 304, the location module 208 determines or receives a location of the one or more identified potential customers. In some embodiments, user 102's position may be continuously located or determined in particular time intervals. The user location(s) may be analyzed to determine the likely user arrival time at a merchant location, or it may be determined that the user 102 is within a particular distance from the merchant location.

Location may be determined by any suitable method or means, including but not limited to, determination by a third-party application, Zigbee® wireless communication devices, GPS, beacon, cell phone triangulation, etc. With mobile devices, geolocation can be determined from the GPS coordinates, WiFi coordinates, and/or cell tower triangulation of the device itself. Regardless of how the user's location is identified, a merchant may be notified when the user meets a predetermined proximity (e.g., distance, location, time, or the like) from a merchant location.

In an exemplary embodiment, a third party, such as another merchant, detects mobile device 120 and broadcasts the location of mobile device 120. For example, in some embodiments, a location application on a user's mobile phone run by a third-party merchant or software may determine the location of the user 102. The third-party merchant server can send a notification of the user 102's location and user ID or mobile ID to the service provider server 180. Service provider server 180 can then receive the location, along with a user ID or mobile ID.

In another exemplary embodiment, a chain of wireless Zigbee® modules is used to communicate a user's location to the service provider server 180. For example, when mobile device 120 is within a certain proximity to an Zigbee® module, mobile device 120 transmits location data to the Zigbee® module by, for example, Bluetooth technology. The Zigbee® module can transmit the location data to another Zigbee® module in proximity, and the location data is relayed to other Zigbee® modules. When one of Zigbee® modules in the chain connects to a network, the location data of mobile device 120 is transmitted to service provider server 180.

In various embodiments, social network data is used to determine a user's location. Social network data may indicate the user 102's recent, present or future location through expressed data. For instance, user 102 may upload a blog post, comment on a connection's page, send a friend an electronic message, or the like, that he or she is traveling to a specific location or that she is currently in a specific city, or on a specific road, or the like. Moreover, many already-existing social networks provide users with the ability to “check-in,” “flag” or otherwise indicate the user's current location. Furthermore, many social networks allow users to rate, like, comment, or the like, on restaurants, attractions, locations or the like. Accordingly, user 102 may indicate that he or she ate at a certain restaurant or business at a given time and thereby provide information about his or her location at that time. Furthermore, a user may upload photographs to a social networking site and thereby provide information about the user's location. In some instances the user's location may be determined from the picture, (for example a picture of a state line sign, a highway sign, a mile marker, or the like) or a caption associated with the picture may indicate the user's location and/or the time the photo was taken.

The amount, nature and type of the location data that is collected and transmitted may depend on the relationship of the service provider with the user 102 and the amount of information that the user 102 has authorized the service provider to collect. For instance, in some embodiments, the location data will be snapshots of the user 102's location at different times. For example, a snapshot of the user 102's location may be collected each time a GPS software, navigation system, or application is activated.

At step 306, the time of arrival module 210 estimates an arrival time of the one or more potential customers based on the location of the potential customers. Once the location of user 102 is determined, the location data is analyzed to project the user 102's likely arrival time at the merchant location. In some instances, analyzing the user 102's location includes projecting the user 102's likely route of travel. This projection may be based on the information currently being collected, such as the user 102's current location, the most recent social network and Internet search data, or the like. In other instances, current user location data may be combined with historical data to project the user 102's likely route of travel. In other embodiments, the analysis may include identifying the distance the user 102 is located away from the merchant.

In an exemplary embodiment, the time of arrival module 210 queries another service, such as Google Maps, to determine a time of arrival. For example, the time of arrival module 210 may provide the location of user 102 to Google Maps, and Google Maps takes the location, determines traffic and routes associated with the location, and provides time of arrival module 210 with an approximate time or times of arrival at the merchant location.

At step 308, the notification module 212 notifies the merchant (e.g., the merchant associated with merchant server 130) of the identities of the one or more potential customers (e.g., user 102) and their estimated arrival times at the merchant location. In various embodiments, the merchant uses this information to prepare an item previously ordered by the customer, ensure sufficient and appropriate staffing of employees, and/or ensure sufficient and appropriate inventory is available. For example, if the merchant knows that user 102 has a preference for purchasing red designer handbags and shoes, the merchant can make certain that red bags and shoes are displayed in the store before user 102 arrives. In another example, the merchant knows that user 102 prefers a particular sales representative (e.g., Ben or Sarah) or a particular type of sales representative (e.g., a female in her late twenties or early thirties) so the merchant can ensure that the sales representative is present and available when user 102 arrives. In yet another example, the merchant knows that 10-20 potential customers will be arriving in half an hour so the merchant requests that employees refrain from taking a break until after the customers leave.

In a further example, the merchant knows user 102 might only be expected to spend 20 minutes at the merchant store. That information can be communicated to an employee so that the employee is mindful of user 102's time, e.g., focusing right away on items of interest, providing the “best” price initially, etc. On the contrary, if the merchant knows user 102 may be expected to spend two hours at the merchant store, employees may alter their engagement, such as trying to upsell or sell complementary items along with the primary item(s) of interest, engage in more negotiating on price, etc. The expected time of user 102 at the store may be determined using information such as a calendar appointment for user 102 later in the day (e.g., one that the user must/likely to keep, such as a doctor's appointment, dinner reservation, concert, theater event, etc.), typical shopping or time spent in the particular store, category of merchant or store, or more generally time spent shopping at particular times/days, and/or social network posts, such as indicating that the user 102 will be at the merchant for the next two hours or that the user will be at a concert or catching a plane at a later time that day. For example, if the user 102's calendar shows a birthday party later in the day and a store visit earlier in the day with no intervening appointments/events, it may be inferred that the user 102 has that entire time (factoring parking and traveling times) to shop at the merchant and be motivated to purchase a birthday gift.

In some embodiments, user profile module 204 forwards user profile and schedule information to the merchant so that the merchant can determine suitable incentives to provide user 102 based on time of arrival, user profile, duration of visit, etc. The incentives can include promotions, discounts, rebates, coupons, free shipping/delivery, free gift, buy one get one free, and other techniques that a retailer might offer to entice user 102 to purchase a product. Many incentives reduce the price of the product below the price displayed on the premises of the physical store. The incentives offered to potential customers can vary and be based on a variety of factors. The incentives may include a price match offering to match an online price, a specific discount amount, such as $5 or 10% off of a listed price, and/or a discounted or free product that will be provided if a certain product is purchased, such as 50% off a related item.

The merchant may utilize the data provided by notification module 212 to select an appropriate incentive to offer to user 102. For example, the merchant may determine that the one or more potential customers satisfy one or more offer criteria. The offer criteria may include, for example, prior purchasing history, repeat customer status, new customer status, particular demographics information, types of linked social networking accounts, threshold amounts of activity (e.g., social networking activity), and other information for determining whether a user is eligible for an incentive.

The merchant may also base the incentive on estimated time of arrival, schedule of the customer, and/or user profile information. For example, if the user profile information indicates that user 102 is a repeat customer, has a high income and has purchased expensive branded clothing and jewelry in the past, the schedule indicates that user 102 only has 15 minutes to spend at the merchant location, and that user 102 is expected to arrive in about an hour. In this case, the merchant can decide to provide user 102 with a 50% off coupon for expensive branded clothing and jewelry to entice user 102 to make a purchase in the short time user 102 spends in the store. In some instances, the incentive is linked to what products user 102 viewed online, but not purchased (e.g., items placed on a wish list or in a shopping cart), and/or to complementary products to previously purchased products (e.g., a matching skirt for a previously purchased blouse).

The merchant may present or transmit the appropriate incentive to the potential customer or customers. In various embodiments, the incentive(s) may be directly transmitted by the merchant to mobile device 120 of the user 102. In other embodiments, the incentive(s) may be sent to the potential customer module 206, which then transmits the incentive(s) to mobile device 120.

The present disclosure describes systems and methods that enhance a customer's in-store experience. A merchant is notified of a potential customer's arrival and estimated time of arrival so that the merchant is sufficiently prepared for the potential customer. The merchant may also provide customized incentives to the potential customer based on his or her time of arrival and the time the customer is expected to stay in the store. Advantageously, the potential customer is not required to send or transmit a message to the merchant to alert the merchant of his or her arrival. Instead, a service provider monitors the behavior and location of potential customers and notifies the merchant of potential customers.

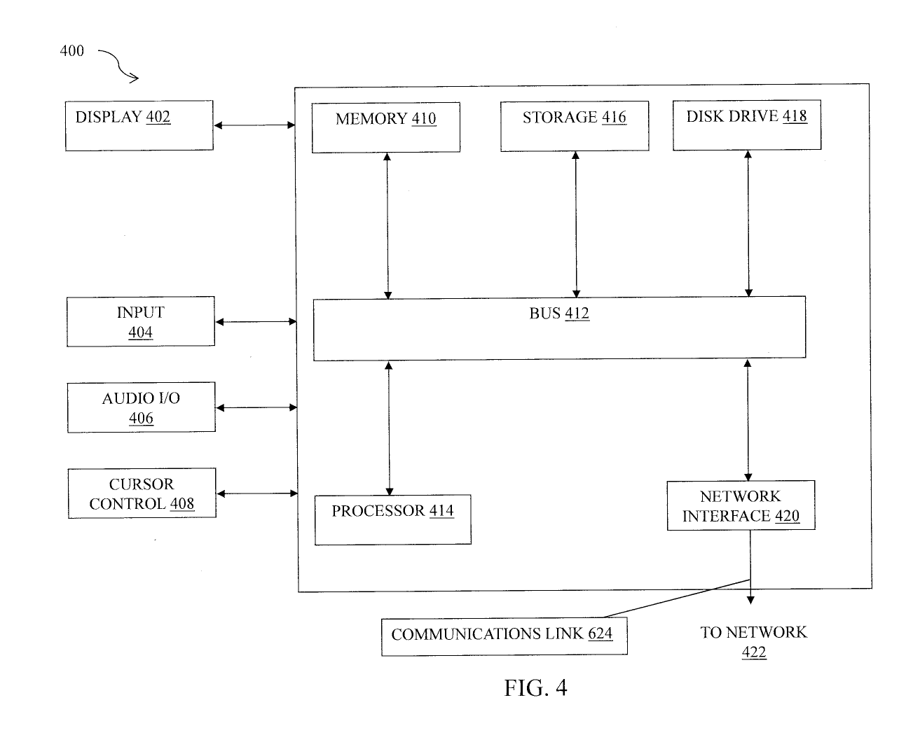

FIG. 4 is a block diagram of a computer system 400 suitable for implementing one or more embodiments of the present disclosure, including the mobile device 120, merchant server 130, and the service provider server 180. In various implementations, the mobile device 120 may include a mobile cellular phone, personal computer (PC), laptop, wearable computing device, etc. adapted for wireless communication, and the merchant server 130 and service provider server 180 may comprise a network computing device, such as a server. Thus, it should be appreciated that the devices 120, 130, and 180 may be implemented as computer system 400 in a manner as follows.

Computer system 400 includes a bus 412 or other communication mechanism for communicating information data, signals, and information between various components of computer system 400. Components include an input/output (I/O) component 404 that processes a user (e.g., sender, recipient, service provider) action, such as selecting keys from a keypad/keyboard, selecting one or more buttons or links, etc., and sends a corresponding signal to bus 412. I/O component 404 may also include an output component, such as a display 402 and a cursor control 408 (such as a keyboard, keypad, mouse, etc.). An optional audio input/output component 406 may also be included to allow a user to use voice for inputting information by converting audio signals. Audio I/O component 406 may allow the user to hear audio. A transceiver or network interface 420 transmits and receives signals between computer system 400 and other devices, such as another user device, a merchant server, or a service provider server via network 422. In one embodiment, the transmission is wireless, although other transmission mediums and methods may also be suitable. A processor 414, which can be a micro-controller, digital signal processor (DSP), or other processing component, processes these various signals, such as for display on computer system 400 or transmission to other devices via a communication link 424. Processor 414 may also control transmission of information, such as cookies or IP addresses, to other devices.

Components of computer system 400 also include a system memory component 410 (e.g., RAM), a static storage component 416 (e.g., ROM), and/or a disk drive 418. Computer system 400 performs specific operations by processor 414 and other components by executing one or more sequences of instructions contained in system memory component 410. For example, processor 414 can determine whether a user will visit a particular merchant, determine or receive a location of a user, estimate a time of arrival of a user, and notify a merchant of potential customers and their time of arrival. Logic may be encoded in a computer readable medium, which may refer to any medium that participates in providing instructions to processor 414 for execution. Such a medium may take many forms, including but not limited to, non-volatile media, volatile media, and transmission media. In various implementations, non-volatile media includes optical or magnetic disks, volatile media includes dynamic memory, such as system memory component 410, and transmission media includes coaxial cables, copper wire, and fiber optics, including wires that comprise bus 412. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 424 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system, comprising:
a potential customer module that identifies one more potential customers that will visit a merchant location and transmits one or more merchant incentives to the one or more potential customers;
a location module that determines or receives a location of the one or more potential customers;
a time of arrival module that estimates a time of arrival at the merchant location of the one or more potential customers; and
a notification module that alerts a merchant at the merchant location of the one or more potential customers and their estimated time of arrival.

2. The system of claim 1, further comprising a user profile module that collects user information, creates a user profile from the user information, and updates the user profile.

3. The system of claim 2, wherein the potential customer module further receives user profile information, schedule or calendar information, or both.

4. The system of claim 3, wherein the potential customer module uses the user profile information, schedule or calendar information, or both, to identify the one or more potential customers.

5. The system of claim 3, wherein the user profile information comprises one or more of a purchase history of a user, personal information of a user, and websites frequently visited by a user.

6. The system of claim 5, wherein the purchase history comprises one or more of where a user has shopped in the past, what a user has bought in the past, what a user has searched for in the past, how much a user has spent in the past, how much time a user spends shopping, and when a user has visited a merchant store.

7. The system of claim 1, wherein the potential customer module further provides the merchant with an estimated time the one or more potential customers will spend at the merchant location.

8. The system of claim 7, wherein the potential customer module further determines the estimated time based on calendar appointments, previous shopping times at the merchant location, category of the merchant, time spent shopping at particular times and days, social network posts, or any combination thereof.

9. The system of claim 1, wherein the time of arrival module projects a likely route of travel, identifies a distance a potential customer is located away from the merchant location, queries a mapping service application, or any combination thereof, to estimate the time of arrival.

10. The system of claim 1, wherein the merchant incentives are based on one or more of a user profile, estimated time of arrival, and duration of visit at the merchant location.

11. A method for enhancing customer service, comprising:
identifying, by a potential customer module of a service provider, a user that will visit a merchant location;
receiving, by a location module of the service provider, a location of the user;
estimating, by a time of arrival module of the service provider, a time of arrival of the user at the merchant location based on the received location;
notifying, by a notification module of the service provider, a merchant at the merchant location of the identified user and the user's estimated time of arrival; and
transmitting, by a user profile module of the service provider, user profile information and schedule information of the user to the merchant.

12. The method of claim 11, wherein the potential customer module identifies the user based on one or more of current actions of the user, past actions of the user, Internet data of the user, and social interaction data of the user.

13. The method of claim 11, wherein the user profile information comprises one or more of a purchase history of a user and personal information of a user, and the schedule information of the user indicates how much time the user can spend shopping.

14. The method of claim 11, further comprising transmitting, by the potential customer module, one or more merchant incentives to the user.

15. The method of claim 14, wherein the one or more merchant incentives are based on the user profile information and the schedule information of the user.

16. The method of claim 11, wherein the time of arrival module projects a likely route of travel, identifies a distance a potential customer is located away from the merchant location, queries a mapping service application, or any combination thereof, to estimate the time of arrival.

17. A non-transitory machine-readable medium comprising instructions which, in response to execution by a computer system, cause the computer system to:
generate, by a user profile module of a service provider, one or more user profiles for one or more users;
identify, by a potential customer module of the service provider, a user that intends to visit a merchant location;
determine, by a location module of the service provider, a location of the user;
estimate, by a time of arrival module of the service provider, a time of arrival of the user at the merchant location;
alert, by a notification module of the service provider, a merchant at the merchant location of the identified user and the user's estimated time of arrival; and
transmit, by the user profile module, the user profile of the user to the merchant, wherein the user profile comprises purchase history and personal information of the user.

18. The non-transitory machine-readable medium of claim 17, wherein the potential customer module identifies the user based on one or more of current actions of the user, past actions of the user, Internet data of the user, and social interaction data of the user.

19. The non-transitory machine-readable medium of claim 17, wherein the method further comprises transmitting, by the potential customer module, one or more merchant incentives to the user.

20. The non-transitory machine-readable medium of claim 19, wherein the one or merchant incentives are based on the user profile of the user.
